(19) United States
(12) Patent Application Publication
(10) Pub. No.: US 2002/0061963 A1
(43) Pub. Date: May 23, 2002

(54) Polyester triglycidyl isocyanurate resin powder coatings based on 1,3-propanediol

(76) Inventors: Shelby Freland Thames, Hattiesburg, MS (US); Oliver Wendell Smith, Petal, MS (US); Lichang Zhou, Cranbury, NJ (US); Wyndham Henry Boon, North Canton, OH (US); Thomas Clayton Forschner, Richmond, TX (US); David Eric Gwyn, Houston, TX (US)

Correspondence Address: Donald F. Haas, Shell Oil Company, Legal-Intellectual Property, P.O. Box 2463, Houston, TX, 77252-2463, US

(21) Appl. No.: 09/940,747

(22) Filed: Aug. 28, 2001

Related U.S. Application Data
(60) Provisional application No. 60/235,024, filed on Sep. 25, 2000.

(51) Int. Cl. C08L 61/00

(52) U.S. Cl. 525/30

(57) ABSTRACT

Disclosed is a carboxyl capped polyester powder coating composition, where the polyester has an acid number of 10 to 100 mg KOH/g, characterized by improved flexibility without significant loss of other properties, said powder coating prepared by substituting 5 to 90 mole % of the aliphatic diol in the polyester resin with 1,3-propanediol, and reacting with one or more dicarboxylic acids and trimethylolpropane, and formulating into a powder coating with a triglycidyl isocyanurate resin.

### FIELD OF INVENTION

This invention relates to a triglycidyl isocyanurate (TGIC) crosslinked polyester powder coating. More particularly, this invention relates to the modification of polyester typically used in carboxyl terminated polyester-TGIC coatings with 1,3-propanediol (PDO) for significantly improved flexibility, impact resistance and lower melt viscosity with other key properties unchanged over a broad range of PDO concentrations.

### BACKGROUND OF THE INVENTION

The development of powder coatings has become increasingly significant in recent years. Powder coatings release no harmful solvents during application, may be applied in a highly efficient manner with little waste arid, thus, are considered particularly environmentally friendly and economical.

Coating powders having a resin system of carboxyl functional polyester and an epoxy curative, such as triglycidyl isocyanurate (TGIC), are known. Typical of a polyester for use in such a coating would be a polymer based on terephthalic acid, neopentyl glycol, and optionally some small amount of modifying monomer, such as ethylene glycol, 1,4-butane diol, 1,6-hexane diol, isophthalic acid, phthalic acid, adipic acid, succinic acid, trimethylol propane, and trimellitic anhydride.

Materials used in the manufacture of powder coatings are classified broadly as either thermosetting or thermoplastic. Thermosetting coatings, when compared to coatings derived from thermoplastic compositions, generally are tougher, more resistant to solvents and detergents, have better adhesion to metal substrates, and do not soften when exposed to elevated temperatures. However, the curing of thermosetting coatings has created problems in obtaining coatings which have, in addition to the above-stated desirable characteristics, good smoothness and flexibility.

Compared to other methods of coating substrates, powder coatings and the powder coating technology offers significant advantages. Powder coating compositions are essentially nonvolatile, generally nontoxic, and are solvent-free. Thus, there are generally no volatile organic compounds or other pollutants given off during preparation, application, or curing. Furthermore, coating processes using powder coating compositions generally produced very little waste because overspray powder can be collected and reused. Thus, in general, powder coatings are preferred to liquid-based coatings. TGIC polyester thermoset powder coatings are known and have been used to form a continuous melt coating on the substrate which then cures to form an even coating.

Coatings derived from thermosetting coating compositions should possess good impact strength, hardness, flexibility, and resistance to solvents and chemicals. For example, good flexibility is essential for powder coating compositions used to coat sheet (coil) steel which is destined to be formed or shaped into articles used in the manufacture of various household appliances and automobiles where the sheet metal is flexed or bent at various angles.

As discussed above, a well known type of coating powder is based on acid functional polyester resin and TGIC as a curative. Such a coating powder is found, for example, in U.S. Pat. Nos. 5,321,100, and 5,187,220, the teachings of each of which are incorporated herein by reference. Polyester coating powders utilizing neopentylgycol are also known.

Neopentyl glycol is often used in formulations for polyester powder coatings along with a mixture of terephthalic and isophthalic acids branched with small amounts of trimethylol propane. Typically when the polyester used in this type of powder coating is modified for improved flexibility, impact, and toughness, then other properties of significance to the coating are compromised. Other potential modifiers include adipic acid, 1,4-butanediol, 1,6-hexanediol, ethylene glycol, and 2-methyl-1,3-propanediol.

Solvent based systems have very different parameters from powder coatings formulations. The T_{g} can be low. Solvent based systems are formulated for solubility, whereas that is not required in powder based coatings.

There does not appear to be any reference in the art which suggests the incorporation of 1,3-propanediol into a polyester triglycidyl isocyanurate powder coating composition for increased flexibility, impact resistance and reduced melt viscosity without the loss of other critical properties.

### SUMMARY OF THE INVENTION

In accordance with the foregoing the present invention comprises a TGIC polyester powder coating exhibiting improved flexibility, without the loss of other key properties, having as the essential elements:

a) from 85 to 96 wt % of a polyester resin characterized by a acid value of about 10 to 100 mg KOH/g, preferably about 20 to 50 mg KOH/g, and a T_{g} of greater than 45 degrees, formed by reacting an aliphatic glycol and a dicarboxylic acid, wherein up to 90 wt %, preferably 5 to 50%, on a molar basis of the aliphatic glycol is 1,3-propanediol;

b) from 4 to 15 wt % of a triglycidyl isocyanurate crosslinking agent; and

c) optionally, conventional catalysts, auxiliary agents and additives.

It has now been demonstrated that by partially replacing the neopentyl glycol with 1,3-propanediol the formulation exhibits improved impact resistance, flexibility and reduced melt viscosity while other key properties essentially remain unchanged over a broad range of 1,3-propanediol concentrations.

### BRIEF DESCRIPTION OF THE DRAWINGS

FIG. 1 shows the glass transition temperatures of various 1,3-propanediol polyester resins.

FIG. 2 shows the differential scanning calorimetry (DSC) curves of various acid polyester resins.

FIG. 3 shows DSC curves of the polyester/triglycidyl isocyanurate (TGIC) powder coatings.

FIG. 4 shows front impact resistance versus film thickness for various powder coatings.

FIG. 5 shows the 20° and 60° gloss of various polyester/TGIC powder coatings.

### DETAILED DESCRIPTION OF THE INVENTION

In the present invention it has been found that replacing neopentyl glycol (NPG) with up to 90%, preferably 15 to 50%, 1,3-propanediol (PDO) on a molar basis provides significant improvements in the flexibility and impact resistance of triglycidyl isocyanurate crosslinked polyester powder coatings, while other properties were about the same as noted in a control using 100% NPG. Properties of coatings made from carboxyl capped polyesters that were examined were flexibility, melt viscosity, processability, storage stability, front/reverse impact at room temperature, 20° and 60° gloss, hardness, adhesion, MEK double rub, and chemical and stain resistance.

The starting materials for the present invention are an aliphatic diols, aromatic dicarboxylic acids, a triglycidyl isocyanurate crosslinking agent, 1,3-propanediol, and optionally conditioning agents, auxiliary agents and other conventional catalysts and additives.

Suitable aliphatic diols have a molecular weight of 62 to 500 and may optionally contain ether groups, ester groups, and/or carbonate groups. Suitable aliphatic diols include, but are not limited to, ethylene glycol, 1,2-propanediol, 2-methyl-1,3-propanediol, 1,3- and 1,4-butanediol, 1,6-hexanediol, diethylene glycol, dipropylene glycol, neopentyl glycol bis(3-hydroxypropyl) ether, and mixtures of these diols. Other suitable diols include triethylene glycol, tetraethylene glycol, tripropylene glycol, tetrapropylene glycol, polycarbonate diols having hydroxyl numbers of 150 to 500, dimeric fatty alcohols and mixtures of these diols. The reactive hydroxyl component can be simple monomeric units or oligomeric units or low molecular weight polymeric units. The preferred diols are aliphatic glycols such as 1,3-butylene glycol or 1,4-butylene glycol; ethylene glycol and propylene glycols; and neopentyl glycol. Neopentyl glycol was most preferred and was used in the examples herein. Also useful is a minor amount of a trihydric or higher alcohol as will be discussed below.

Suitable acids include saturated, unsaturated, aliphatic, or aromatic dicarboxylic acids such as phthalic, isophthalic, terephthalic, 2,6-naphthalenedicarboxylic, sebacic, maleic, fumaric, succinic, adipic, azelaic, malonic, dodecanedioic, and similar dicarboxylic acids. The dicarboxylic acids preferred in the present invention were isophthalic and terephthalic, used individually or mixed, in a molar ratio of terephthalic to isophthalic of about 100/0 to 0/100, typically about 80/20.

A branching agent is also useful, such as, for example, a small amount of a triol or higher alcohol. Suitable branching agents include, but are not limited to trimethylol-ethane, trimethylolpropane, or pentaerythritol. Trimethylolpropane was used in the examples below.

The carboxyl functional polyesters used in the invention were synthesized by a two stage process. In stage 1, terephthalic acid (TPA), isophthalic acid (IPA) and NPG/PDO diols are reacted at a temperature in the range of 150-250° C., preferably 170 to 230° C., to form a hydroxy-functional prepolymer. In stage 2, the balance of isophthalic acid (IPA) is added to cap the hydroxyl groups and the esterification is continued to an acid value of 30 to 45 KOH/g. The total reaction time is approximately 10 to 15 hours. A conventional catalyst for promotion of an esterification reaction, such as dibutyltin oxide, can be used in catalytic amounts of 0.01 to 1 wt %. Xylene/water is added before the reaction started to facilitate the removal of water formed during the reaction. 1,3-propanediol was substituted for neopentyl glycol in molar increments of 0, 15, 30, 50, and 100%.

There are alternative ways of carrying out the reaction, as will be apparent to those skilled in the art. A commercial scale reaction would probably rarely use xylene/water and could start with an ester, such as dimethylterephthalate (DMT) or dimethylisophthalate (DMI). It is also possible to charge all the acids at stage 1 and not delay addition of isophthalic acid. It is also possible to use acid chlorides and acid anhydrides.

Powder coatings were prepared from the 1,3-propanediol derived polyesters formulated with a triglycidyl isocyanurate resin crosslinking agent, a flow control agent, and optionally a catalyst. Conventional pigmenting materials (pigments or dye), such as titanium dioxide, may also be included in the formulation to impart a desirable color to the coated substrate.

Other suitable epoxy resins for use herein include TGIC compounds or derivatives thereof. These resins have a number average molecular weight in the range of 290 to 500. Specific examples of such derivatives include methyl substituted triglycidyl isocyanurate, ethyl substituted triglycidyl isocyanurate, and the like. The preferred TGIC has an epoxy content of at least about 90 to about 108 grams per equivalent with a melting point of about 88° C. to about 98° C. TGIC is available as ARALDITE® PT-810 from Ciba Geigy Company. When a TGIC compound or derivative thereof is used, it is present in an amount of at least about 0.1 to about 30 parts by weight, more preferably about 2 to about 10 parts by weight. The TGIC compound or derivative thereof provides excellent hardening properties and blocking resistance. Though an isocyanurate ring is included in the present invention, it is excellent in flexibility because of the presence of the ester bonding and has superior curing properties. The cured coating is excellent in flexibility over a wide range of low to high temperature exposure. In addition, the coating has excellent coating appearance and higher qualities.

A flow control or leveling agent is desirably incorporated into the coating formulation to aid in leveling the applied and thermoset coatings. Such flow control agents typically comprise acrylic polymers and are available from several suppliers, i.e., MODAFLOW from Monsanto Company, BYK 360P from BYK Mallinkrodt and ACRONAL from BASF. A suitable concentration range for incorporation of the flow control agent into the coating was 0.25-1.5% based on the weight of the resin solids, and preferably in the range of 0.60-1.5%.

The powder coatings can be cured or crosslinked without the use of a catalyst. However, it has found it to be a practical necessity to include a catalyst to promote the crosslinking reaction of the epoxy resin with the polyesters. The uncatalyzed rate of reaction has been found to be too slow to suit the baking schedules established in the industry. Suitable catalysts include amine containing compounds (such as amides, imides, imidazoles, and quaternary ammonium salts), phosphonium salts, metal salts of acidic and fatty acids, tin and zinc compounds, and the like. Specific samples of the these catalysts are tetrabutylammonium chloride and choline chloride. These catalysts may be used either alone or in combination. Further, as the kind and amount of the catalyst to be used are variable depending on the kind and amount of the resin and the curing conditions, careful selection is necessary to meet the required performance. A suitable concentration range for incorporation of the catalyst into the coating is about 0.01-1% based on the weight of the resin solids, and preferably in the range of 0.05-0.5%.

The following examples will serve to illustrate specific embodiments of the invention disclosed herein. These examples are intended only as a means of illustration and should not be construed as limiting the scope of the invention in any way. Those skilled in the art will recognize many variations which may be made without departing from the spirit of the disclosed invention.

### EXAMPLES

Synthesis of Carboxyl Functional Polyesters

Carboxyl functional polyesters were synthesized in 1 liter round bottom flask under a nitrogen purge using a two-stage process. In stage 1, raw materials including TPA, IPA, NPG and PDO were charged to the reactor and the mixture was heated at 170 to 230° C. to form a hydroxy-functional prepolymer. In stage 2, IPA was added to cap the hydroxyl groups and the esterification was continued to an acid value of 30 to 45. The total reaction time was approximately 10 to 15 hours. Dibutyltin oxide (0.4%) was used as a catalyst, and xylene and water were added to facilitate water removal during the reaction. Polyester compositions with molar substitutions of PDO for NPG from 0 to 100 percent are listed in Table 1.

TABLE 1
Molar Composition of the Carboxyl Functional
Polyester Resins

| Ingredients | TE00 | TE15 | TE30 | TE50 | TE100 |
|---|---|---|---|---|---|
| NPG/PDO (mole) | 100/0 | 85/15 | 70/30 | 50/50 | 0/100 |
| Terephthalic Acid (TPA) | 2.032 | 2.064 | 2.098 | 2.146 | 2.274 |
| Isophthalic Acid (IPA) | 0.226 | 0.229 | 0.233 | 0.238 | 0.253 |
| Neopentyl Glycol (NPG) | 2.288 | 1.975 | 1.653 | 1.207 | 0.000 |
| 1,3-Propanediol (PDO) | 0.000 | 0.349 | 0.708 | 1.207 | 2.557 |
| Trimethylolpropane (TMP) | 0.121 | 0.121 | 0.121 | 0.121 | 0.120 |
| Isophthalic Acid (IPA) | 0.405 | 0.405 | 0.405 | 0.403 | 0.400 |
| (Stage 2) | | | | | |

Preparation of Powder Coatings

Polyester powder coatings prepared from PDO derived polyesters were formulated with triglycidyl isocyanurate resin via equal equivalents of carboxyl/epoxy groups. For the compositions of this invention the ratio of epoxy to carboxyl is in the range of 0.5/1 to 6/1. PT-810 (TGIC) triglycidyl isocyanurate resin from Ciba Geigy Corp. was used as a crosslinking agent for the polyesters. Choline chloride (0.18%, Actiron CT-6 from Synthron, Inc.) was used as a catalyst. Flow control agent (Modaflow Powder III from Monsanto) and degassing agent benzoin (Uraflow-B from GCA Chemical Corporation) were also incorporated into the coatings. Pigmented powder coatings based on R-960 TiO₂ (DuPont) at a pigment/binder ratio of 0.7/1 by weight were also evaluated. The final powder coating compositions are listed in Table 2.

TABLE 2
Powder Coatings Formulations

| Ingredients | T-00 | T-15 | T-30 | T-50 | T-100 | PT-00 | PT-15 | PT-30 |
|---|---|---|---|---|---|---|---|---|
| TE00 | 91.13 | — | — | — | — | 54.55 | — | — |
| TE15 | — | 91.70 | — | — | — | — | 54.89 | — |
| TE30 | — | — | 91.73 | — | — | — | — | 54.91 |
| TE50 | — | — | — | 91.26 | — | — | — | — |
| TE100 | — | — | — | — | 91.35 | — | — | — |
| TGIC PT-810 | 7.11 | 6.54 | 6.51 | 6.98 | 6.90 | 4.26 | 3.91 | 3.90 |
| DuPont R-960 | — | — | — | — | — | 39.40 | 39.40 | 39.40 |
| TiO2 | | | | | | | | |
| Choline Chloride | 0.18 | 0.18 | 0.18 | 0.18 | 0.18 | 0.12 | 0.12 | 0.12 |
| Modaflow Powder | 1.18 | 1.18 | 1.18 | 1.18 | 1.18 | 1.18 | 1.18 | 1.18 |
| III | | | | | | | | |
| Benzoin | 0.40 | 0.40 | 0.40 | 0.40 | 0.40 | 0.50 | 0.50 | 0.50 |
| Total | 100 | 100 | 100 | 100 | 100 | 100 | 100 | 100 |

All the ingredients were initially premixed in a high speed mixer for 2 minutes to assure homogeneous mixing and the solids were then fragmented into small particles. The resulting intimate mixture was then continuously processed through a twin screw extruder to produce a uniform viscous melt. The extrusion temperature was maintained at 80° C. in both zones 1 and 2 at a processing speed of 120 rpm. Molten extrudates passed through a pair of water-cooled squeeze rolls afforded a friable product. The products were then pulverized using a hammer mill with liquid nitrogen fed slowly into the grinding chamber. Classification on an Alpine sieve afforded powders with particle sizes of 105 microns or less.

The final powders were electrostatically sprayed onto grounded cold-rolled steel panels (Q Panel S-36), and coating properties were evaluated after curing at 180° C. for 18 minutes.

Characteristics of Polyester Resins:

The PDO based carboxyl functional polyester resins afforded properties similar to those based on NPG (Table 3). Glass transition temperatures (Tg) of the polyesters decreased with increasing PDO contents (FIG. 1). For example, the Tg values ranged from 640C for the NPG polyester to 52° C. for the 50 percent PDO polyester. Glass transition temperatures for the carboxyl functional polyesters were 4 to 6 degrees higher than the corresponding hydroxyl functional polyesters. This characteristic of the carboxyl polyesters is expected to improve the storage stability of the corresponding powder coatings. Tg's for the polyesters were reported for the second heating cycle via differential scanning calorimetry (DSC) at a scanning rate of 10° C./minute. The second heating cycle involved heating the samples to a melt and then cooling the resin prior to measuring the Tg.

TABLE 3
Carboxyl Functional Polyesters Properties

| | TE00 | TE15 | TE30 | TE50 | TE100 |
|---|---|---|---|---|---|
| NPG/PDO (mole) | 100/0 | 85/15 | 70/30 | 50/50 | 0/100 |
| Carboxyl Equivalent | 1410 | 1543 | 1549 | 1438 | 1457 |
| Acid Number, | 39.7 | 36.4 | 36.2 | 39.0 | 38.5 |
| mg KOH/g Polymer | | | | | |
| Color Before Grinding | Clear | Clear | Clear | Clear | Sl. |
| | | | | | Yellow |

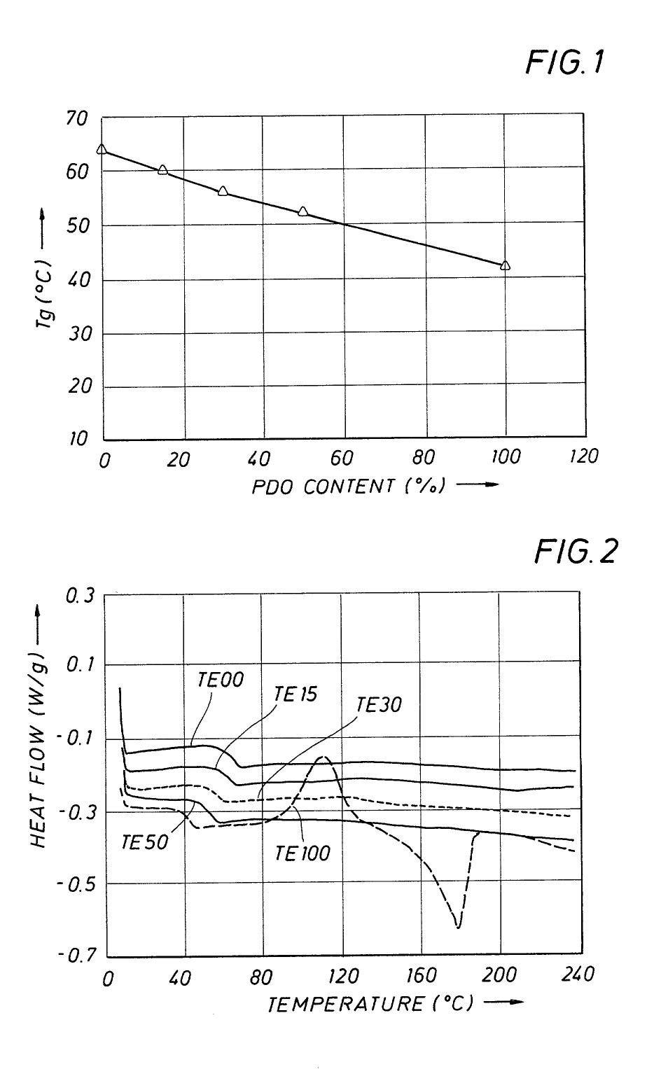

No crystallization or melting peaks were noted on the DSC curves of polyesters derived from NPG or NPG/PDO mixtures, indicating amorphous polyesters (FIG. 2). However, the polyester from pure PDO was a semi-crystallized polymer with crystallization and melting temperatures of approximate 109 and 188° C., respectively. Therefore, partially replacing NPG with PDO up to 50 molar percent provided amorphous polyesters suitable for coating applications. It should be noted that the carboxyl polyesters were similar to hydroxyl polyesters with respect to amorphous characteristics.

Reactivity of Polyesters:

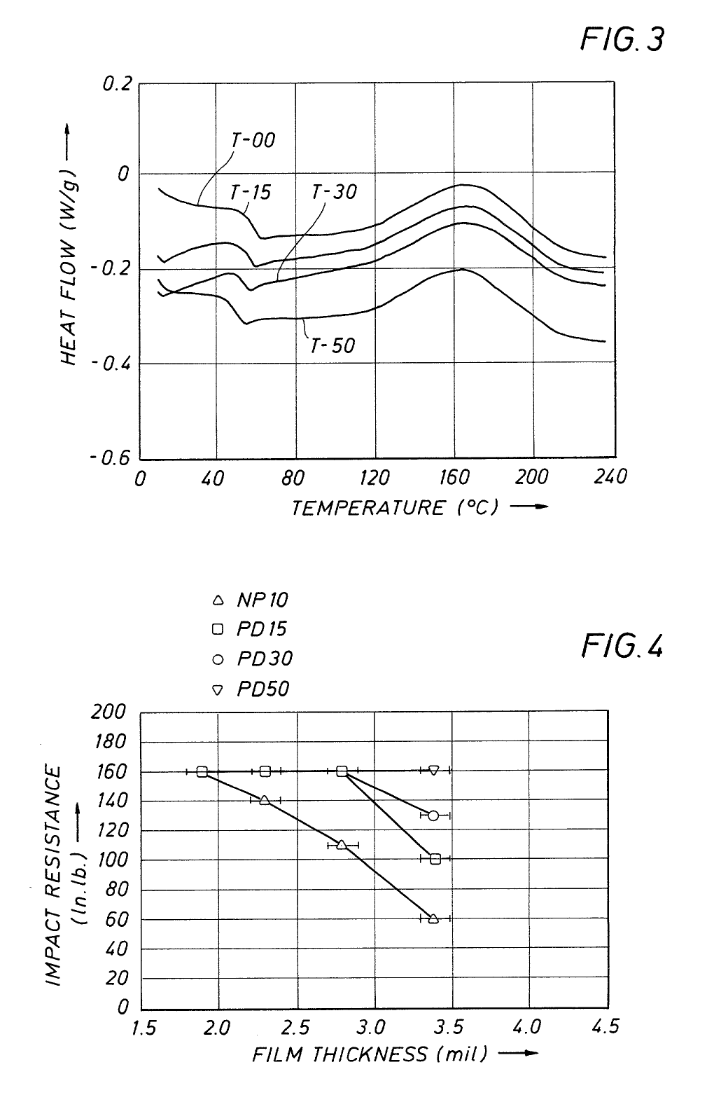

The reactivity of carboxyl functional polyester powders with TGIC resin crosslinking agent was studied via DSC at a scanning rate of 10° C./minute. DSC curves shown in FIG. 3 and testing results listed in Table 4 indicate the onset of cure—exothermal peak and enthalpy are very close for all of the PDO derived and NPG control coatings. Thus, polyesters based on NPG and PDO/NPG mixtures had similar reactivities with the TGIC crosslinking agent.

TABLE 4
DSC Results of the Reactivity of Powders

| | T-00 | T-15 | T-30 | T-50 |
|---|---|---|---|---|
| PDO % | 0 | 15 | 30 | 50 |
| Onset Temperature (° C.) | 115 | 115 | 114 | 114 |
| Peak (° C.) | 166 | 167 | 167 | 164 |
| Enthalpy (J/g) | 42.97 | 41.46 | 42.50 | 41.46 |

Processability:

After premixing, the intimate powder mixture was continuously processed through a twin screw extruder to produce a uniform viscous melt. The extrusion temperature was maintained at 80° C. in both zones 1 and 2 at 120 rpm. All of the powder mixtures from NPG and NPG/PDO polyesters were easily processed through the extruder (Table 5). It was observed that the torque reduced with increasing the PDO content in the polyesters, indicating the reduction in the polyester viscosity. The powder based on 100% 1,3-propanediol cannot be processed under the conditions due to its crystallinity and high melting point.

TABLE 5
Processability of Polyester Powder Coatings

| | T-00 | T-15 | T-30 | T-50 | T-100 | PT-00 | PT-15 | PT-30 |
|---|---|---|---|---|---|---|---|---|
| Torque | 83% | 77% | 71% | 68% | >105% | 88% | 81% | 76% |
| Temperature, Zone 1 | 80 | 80 | 80 | 80 | 80 | 80 | 80 | 80 |
| (° C.) | | | | | | | | |
| Temperature, Zone 2 | 80 | 80 | 80 | 80 | 80 | 80 | 80 | 80 |
| (° C.) | | | | | | | | |
| Processability | Good | Good | Good | Good | Poor | Good | Good | Good |

Storage Stability:

The glass transition temperature of polyester resins for powder coatings should be high enough to achieve good storage stability. The T_{g} of polyester/TGIC powder precursors was measured via DSC and listed in Table 6. As expected, powder coatings formulated with up to 50% PDO derived carboxyl polyesters had very good storage stability, since they had T_{g} values over 50° C.

TABLE 6
Tg of Polyester Powder Coatings Precursors and
Storage Stability

| | T-00 | T-15 | T-30 | T-50 | PT-00 | PT-15 | PT-30 |
|---|---|---|---|---|---|---|---|
| PDO % | 0 | 15 | 30 | 50 | 0 | 15 | 30 |
| Tg of Precursor | 58 | 56 | 53 | 50 | — | — | — |
| Powder (° C.) | | | | | | | |
| Storage | Pass | Pass | Pass | Pass | Pass | Pass | Pass |
| Stability | | | | | | | |

Storage stability tests were performed by placing powders in a capped jar at 40° C. for 10 days. Powders were subsequently examined for free-flowing properties (lumps not easily broken) each day for 10 days. Those with free-flowing properties after 10 days passed the test.

Inclined Plate Flow:

The inclined plate flow properties of powder coatings were measured according to the PCI standard method. It is a useful indicator of the degree of flow occurring during the curing of powder coated parts. The inclined plate flow is related to the melt viscosity of the base resin and is influenced by the reactivity of crosslinking agent and the polyester resins. It was noted that the plate flow increased with increasing PDO concentrations in the PDO/NPG mixtures at both 175° C. and 190° C. (Table 7). Therefore, incorporation of PDO improved the flow properties of the powder coatings. The powders also had higher plate flows at 175° C. than at 190° C., because of higher reaction rates at higher temperatures.

TABLE 7
Inclined Plate Flow and Gel Time Test Results

| | T-00 | T-15 | T-30 | T-50 | PT-00 | PT-15 | PT-30 |
|---|---|---|---|---|---|---|---|
| PDO % | 0 | 15 | 30 | 50 | 0 | 15 | 30 |
| Flow at | 45 | 43 | 46 | 55 | 27 | 27 | 32 |
| 175° C. (mm) | | | | | | | |
| Flow at | 41 | 40 | 43 | 47 | 26 | 25 | 30 |
| 190° C. (mm) | | | | | | | |
| Gel Time at | 180 | 160 | 160 | 165 | 270 | 240 | 250 |
| 180° C. | | | | | | | |
| (seconds) | | | | | | | |

Gel Time Reactivity:

Gel time reactivity is the time required for a powder to advance to a gelled state through a liquid phase at a defined temperature. The test was performed via rubbing the powder coating with the tip of a wooden applicator stick over a hot plate until a solid gel was produced. Gel times for polyester powder coatings were determined at 180° C. according to the PCI standard method. As seen in Table 7, all the coatings provided similar gel times, which is in accord with DSC studies.

Impact Resistance:

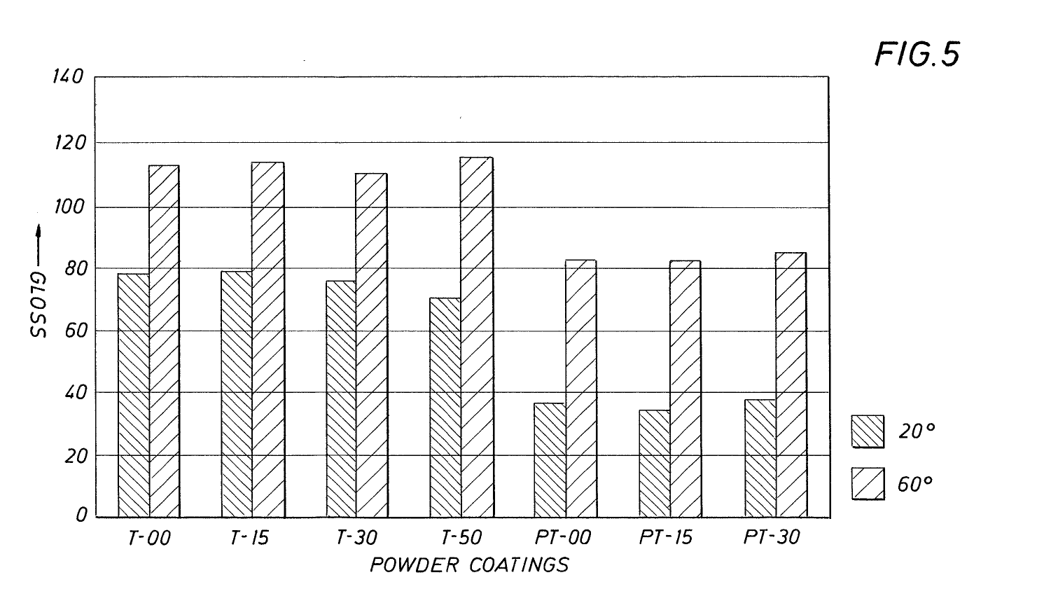

Front and reverse impact resistance was tested according to the ASTM D-2794 standard method. The results in Table 8 indicated that PDO significantly improved the flexibility of both polyester/TGIC clear and pigmented powder coatings. For instance, the impact resistance increased from 60/30 in-lbs (front impact/reverse impact) (6.7/3.4 N-m, Newton-meters) for the coating based on pure NPG polyester to 130/130 in-lbs (14.7/14.7 N-m) for 30% PDO and to 160/160 in-lbs (18.1/18.1 N-m) for 50% PDO derived polyesters at the film thickness around 3.3 mils (0.084 mm). Moreover, the impact resistance was strongly dependent on film thickness with thicker films having less flexibility. The coating properties had some variation in front and reverse impact flexibility of PDO coating compositions at various film thicknesses (see FIG. 4 also).

TABLE 8
Front/Reverse Impact Resistance of Polyester/TGIC Powder Coatings

| Film | | | | | | | |
|---|---|---|---|---|---|---|---|
| Thickness | T-00 | T-30 | T-30 | T-50 | PT-00 | PT-30 | PT-30 |
| (mil) | (in. lb.) | (in. lb.) | (in. lb.) | (in. lb.) | (in. lb.) | (in. lb.) | (in. lb.) |
| (mm) | (N-m) | (N-m) | (N-m) | (N-m) | (N-m) | (N-m) | (N-m) |
| 1.4-1.6 | — | — | — | — | 130/130 | 160/160 | 160/160 |
| (0.036- | | | | | (14.7/14.7) | (18.1/18.1) | (18.1/18.1) |
| 0.041) | | | | | | | |
| 1.8-2.0 | 160/160 | 160/160 | 160/160 | 160/160 | — | — | — |
| (0.046- | (18.1/18.1) | (18.1/18.1) | (18.1/18.10 | (18.1/18.1) | | | |
| 0.051) | | | | | | | |
| 1.9-2.2 | — | — | — | — | 100/90 | 160/160 | 160/160 |
| (0.048- | | | | | (11.3/10.7) | (18.1/18.1) | (18.1/18.1) |
| 0.056) | | | | | | | |
| 2.2-2.4 | 140/140 | 160/160 | 160/160 | 160/160 | — | — | — |
| (0.056- | (15.8/15.8) | (18.1/18.1) | (18.1/18.1) | (18.1/18.1) | | | |
| 0.061) | | | | | | | |
| 2.4-2.6 | — | — | — | — | 80/60 | 160/160 | 160/160 |
| (0.061- | | | | | (9.0/6.7) | (18.1/18.1) | (18.1/18.1) |
| 0.066) | | | | | | | |
| 2.6-2.9 | 110/100 | 160/160 | 160/160 | 160/160 | — | — | — |
| (0.066- | (12.4/11.3) | (18.1/18.1) | (18.1/18.1) | (18.1/18.1) | | | |
| 0.074) | | | | | | | |
| 3.3-3.5 | 60/30 | 100/80 | 130/130 | 160/160 | — | — | — |
| (0.084- | (6.7/3.4) | (11.3/9.0) | (14.7/14.7) | (18.1/18.1) | | | |
| 0.089) | | | | | | | |

Flexibility-Conical Mandrel Bend and T-Bend Test:

Conical mandrel bend tests were performed via bending the coating panels on a conical mandrel tester (Gardner Laboratory, Inc., 1/8″ [3.175 mm] diameter) over a period of 3 seconds. The testing results are listed in Table 9. All clear and pigmented coating panels passed the test, i.e., there was no cracking.

TABLE 9
Conical Mandrel Bend and T-Bend Test Results

| | T-00 | T-15 | T-30 | T-50 | PT-00 | PT-15 | PT-30 |
|---|---|---|---|---|---|---|---|
| PDO % | 0 | 15 | 30 | 50 | 0 | 15 | 30 |
| Film Thickness | 1.8 | 1.7 | 1.7 | 1.6 | 1.7 | 1.7 | 1.7 |
| (mil) (mm) | (0.046) | (0.043) | (0.043) | (0.041) | (0.043) | (0.043) | (0.043) |
| ⅛″ Conical | Pass | Pass | Pass | Pass | Pass | Pass | Pass |
| Mandrel Bending | | | | | | | |
| T-Bend | 2T | 1T | 0T | 0T | 3T | 2T | 0T |

Flexibility measured via the T-bend test revealed that incorporation of 15% PDO provided a 1T coating whereas pure NPG resulted in a 2T value. Coatings containing 30 and 50% PDO provided very good flexibility with OT values. In the case of the pigmented coatings, pure NPG resulted in a 3T value compared to a 2T when 15% PDO and OT when 30% PDO was incorporated. Therefore, these results provide further data on the contribution of PDO to improved flexibility for the powder coatings.

Gloss:

20 and 60 degrees gloss values for the polyester/epoxy clear and pigmented powder coatings are presented in FIG. 5. Incorporation of PDO gave similar gloss values in both clear and pigmented coatings compared to pure NPG coatings.

Hardness, Adhesion, and MEK Double-rub Resistance:

All coatings evaluated had excellent adhesion to cold rolled steel substrates (Table 10). They passed the crosshatch tape adhesion test in accordance with ASTM D-3359-92 with a value of 5B. Replacing NPG with PDO had little effect on the final pencil hardness. In the case of MEK double rub resistance, PDO derived polyesters showed similar values when compared to pure NPG for both clear and pigmented coatings. Therefore, coatings based on PDO/NPG mixture combined good film hardness, impact flexibility with high gloss, and excellent adhesion.

TABLE 10
Hardness, Adhesion, and MEK Double-Rub
Resistance Properties

| Properties | T-00 | T-15 | T-30 | T-50 | PT-00 | PT-15 | PT-30 |
|---|---|---|---|---|---|---|---|
| Film Thickness | 1.8 | 1.7 | 1.7 | 1.6 | 1.7 | 1.7 | 1.7 |
| (mil) (mm) | (0.046) | (0.043) | (0.043) | (0.041) | (0.043) | (0.043) | (0.043) |
| Pencil Hardness | HB | HB | HB | HB | 2H | 2H | 2H |
| Adhesion | 5B | 5B | 5B | 5B | 5B | 5B | 5B |
| MEK Double-Rubs | 50 | 50 | 50 | 50 | 80 | 80 | 80 |

Chemical and Stain Resistance:

Coatings exposed to 10% HCl, 10% NaOH, gasoline, and mustard for 24 hours had excellent acid resistance compared to the control. Gasoline and 10% NaOH had a very slight affect on both PDO and NPG polyester coatings after a 24-hour exposure. All coatings exhibited very good stain resistance to mustard. It was apparent that the stain resistance was not only connected to the chemical resistance but also to the hardness of the coatings. Harder resins had better stain resistance than soft resins. PDO derived coatings had little affect on the pencil hardness and the chemical resistance, hence no effect on the stain resistance was observed (Table 11). The data is presented in the form of ratings with 10 representing no effect and 1 indicating the most severe deterioration.

TABLE 11
Chemical and Stain Resistance of Powder Coatings

| | T-00 | T-15 | T-30 | T-50 | PT-00 | PT-30 | PT-30 |
|---|---|---|---|---|---|---|---|
| 10% HCl | 10 | 10 | 10 | 10 | 10 | 10 | 10 |
| 10% NaOH | 9 | 9 | 9 | 9 | 9 | 9 | 9 |
| Mustard | 10 | 10 | 10 | 10 | 10 | 10 | 10 |
| Gasoline | 9 | 9 | 9 | 9 | 9 | 9 | 9 |

Water Resistance and Salt Spray Testing:

Water resistance was tested according to ASTM D-2247, involving exposure of the coated panels to water steam at 40° C. in a chamber. It is reported that steric hindrance is a major controlling factor in the rate of hydrolysis of polyester binders. However, the testing results indicated very good water resistance for both PDO derived resins and the NPG control by passing over 1000 hours without failure.

Salt spray corrosion data (Table 12) shows no noticeable differences either for both PDO derived and NPG control powder coatings. This test was performed via exposure in a chamber to 5 percent sodium chloride solution at a temperature of 35° C. for 1000 hours over cold rolled steel panes (S-36 from Q Panel).

Yellowing Resistance in Overbake:

Yellowing resistance after overbake was determined by placing films in an oven at 200° C. for 15, 30, 45, and 60 minutes. Color B and yellowness index were then measured after 24 hours at room temperature. The results indicate that PDO derived polyester powder coatings showed similar yellowing resistance after overbaking compared to the NPG control (Table 13).

TABLE 12
Water Resistance, Weathering and Salt Spray Testing

| | T-00 | T-15 | T-30 | T-50 | PT-00 | PT-15 | PT-30 |
|---|---|---|---|---|---|---|---|
| Film Thickness (mil) (mm) | 1.8 | 1.7 | 1.7 | 1.6 | 1.7 | 1.7 | 1.7 |
| | (0.046) | (0.043) | (0.043) | (0.041) | (0.043) | (0.043) | (0.043) |
| Water Resistance (hours) | >1000 | >1000 | >1000 | >1000 | >1000 | >1000 | >1000 |
| Salt Spray (1000 hours) | | | | | | | |
| Rust Creepage | 1/8- | 1/8- | 1/8- | 1/8- | 1/16- | 1/16- | 1/16- |
| (in.) (mm) | 3/16 | 3/16 | 3/16 | 3/16 | 1/8 | 1/8 | 1/8 |
| | (3.175- | (3.175- | (3.175- | (3.175- | (1.588- | (1.588- | (1.588- |
| | 4.762) | 4.762) | 4.762) | 4.762) | 3.175) | 3.175) | 3.175) |
| Blistering | None | None | None | None | None | None | None |

TABLE 13
Color B and Yellowness Index Change of Coatings
after Overbaking at 200° C.

| | T-00 | T-15 | T-30 | T-50 | PT-00 | PT-15 | PT-30 |
|---|---|---|---|---|---|---|---|
| PDO % | 0 | 15 | 30 | 50 | 0 | 15 | 30 |
| Film Thickness | 1.8 | 1.7 | 1.7 | 1.6 | 1.7 | 1.7 | 1.7 |
| (mil) (mm) | (0.046) | (0.043) | (0.043) | (0.041) | (0.043) | (0.043) | (0.043) |
| Color B Change | | | | | | | |
| 15 min | 1.22 | 1.19 | 1.14 | 1.25 | 0.16 | 0.17 | 0.18 |
| 30 min | 2.03 | 2.01 | 1.89 | 2.09 | 0.20 | 0.21 | 0.22 |
| 45 min | 2.49 | 2.56 | 2.49 | 2.67 | 0.24 | 0.23 | 0.25 |
| 60 min | 3.1 | 3.1 | 3.08 | 3.15 | 0.33 | 0.3 | 0.34 |
| Yellowness Index Change | | | | | | | |
| 15 min | 2.70 | 2.60 | 2.53 | 2.78 | 0.24 | 0.26 | 0.27 |
| 30 min | 4.38 | 4.37 | 4.21 | 4.58 | 0.31 | 0.33 | 0.34 |
| 45 min | 5.60 | 5.56 | 5.51 | 5.84 | 0.37 | 0.35 | 0.39 |
| 60 min | 6.85 | 6.73 | 6.83 | 6.96 | 0.52 | 0.47 | 0.53 |

These results show that carboxyl functional polyesters have been synthesized from mixtures of 1,3-propanediol (PDO) and neopentyl glycol (NPG). Increasing molar concentrations of PDO, i.e., 0, 15, 30, 50, and 100%, reduced the glass transition temperature of the polyesters.

Powder coating formulations based on these polyesters and TGIC crosslinking agent were easily processed in an extruder. The viscosity of the polyester decreased as the level of PDO increased, hence improved flowability resulted. Polyesters containing up to 50% PDO in the polyol mixture had good storage stability due to their higher T_{g}. Coatings properties indicated that replacing NPG with PDO significantly improved both impact resistance and flexibility. Other properties including hardness, adhesion, and chemical resistances were retained over a broad range of PDO concentrations.

We claim:

1. A polyester powder coating composition having as the essential elements:
a) from 85 to 96 wt % of a polyester resin formed by reacting an aliphatic glycol and one or more dicarboxylic acids, wherein the aliphatic glycol is 5 to 90% on a molar basis 1,3-propanediol;
b) from 4 to 15 wt % of a triglycidyl isocyanurate crosslinking agent; and
c) optionally conventional catalysts, auxiliary agents, and additives.

2. The powder coating composition of claim 1 wherein the aliphatic glycol is selected from the group consisting of 1,3-butylene glycol, 1,4-butylene glycol, ethylene glycol, propylene glycol, 2-methyl-1,3-propanediol, 1,6-hexanediol, and neopentyl glycol.

3. The powder coating composition of claim 2 wherein the aliphatic glycol is neopentyl glycol.

4. The powder coating composition of claim 2 further comprising minor amounts of branching agents selected from the group consisting of trimethylolpropane, trimethylolethane, and pentaerythritol.

5. The powder coating composition of claim 1 wherein the polyester resin comprises:
a) neopentyl glycol substituted with 15 to 50% on a molar basis 1,3-propanediol; and
b) one or more dicarboxylic acids.

6. The powder coating composition of claim 1 wherein the dicarboxylic acids are selected from the group consisting of saturated, unsaturated, aliphatic, or aromatic dicarboxylic acids.

7. The powder coating composition of claim 6 wherein the dicarboxylic acids are selected from the group consisting of phthalic, isophthalic, terephthalic, naphthalenedicarboxylic, sebacic, maleic, fumaric, succinic, adipic, azelaic, malonic or mixtures thereof.

8. The powder coating composition of claim 7 wherein the dicarboxylic acids are selected from isophthalic and terephthalic, separately or a mixture thereof.

9. The powder coating composition of claim 8 wherein terephthalic and isophthalic acid are used in a molar ratio of terephthalic to isophthalic of about 100/0 to 0/100.

10. The powder coating composition of claim 9 wherein the molar ratio of terephthalic to isophthalic acid is about 80/20.

11. The powder coating composition of claim 1 wherein 5-90% molar of the aliphatic glycol is 1,3-propanediol.

12. The powder coating composition of claim 1 further comprising the optional addition of conventional auxiliary agents and additives.

13. The powder coating composition of claim 1 further comprising the ratio of epoxy to carboxyl is in the range of 0.5/1 to 6/1.

14. A polyester powder coating composition having as the essential elements:
a) a polyester resin characterized by a acid value of 10 to 100 mg KOH/g formed by reacting neopentyl glycol with a mixture of terephthalic acid and isophthalic acid, wherein the ratio of terephthalic to isophthalic is in the molar range of 100/0 to 0/100, and wherein 15-50% on a molar basis of the neopentyl glycol is substituted with 1,3-propanediol; and
b) a triglycidyl isocyanurate.

15. Any coated product made using the powder coating of claim 1.
